(19) United States
(12) Patent Application Publication
(10) Pub. No.: US 2024/0009832 A1
(43) Pub. Date: Jan. 11, 2024

(54) WEARABLE MECHANICAL ROBOTIC DEVICE

(71) Applicant: Auspurger Komm Engineering, Inc., Phoenix, AZ (US)

(72) Inventors: Kevin Hollander, Scottsdale, AZ (US); Brandon Martin, Gilbert, AZ (US)

(73) Assignee: Auspurger Komm Engineering, Inc., Phoenix, AZ (US)

(21) Appl. No.: 18/219,180

(22) Filed: Jul. 7, 2023

Related U.S. Application Data
(60) Provisional application No. 63/359,059, filed on Jul. 7, 2022.

(51) Int. Cl. B25J 9/00; B25J 9/10; A61H 3/00

(52) U.S. Cl. CPC B25J 9/0006; B25J 9/109; A61H 3/00; A61H 2003/007

(57) ABSTRACT

A housing can have a first attachment point for an actuator wherein the actuator can be attached to the housing and a pin lift plow. The wearable mechanical robotic device can have a rolling pin lock. A cam wherein the cam can rotate around an axis and can come into contact with a cam follower and the rolling pin lock. A plunger wherein the plunger can be attached to the cam follower wherein the plunger compresses a spring against a base. An outer frame having at least one guide for the rolling pin lock. The housing can have at least one second attachment point wherein at least one frame is attached to the housing by at least one fastener.

### CROSS REFERENCE TO RELATED APPLICATION

This application claims benefit from currently pending U.S. Provisional Application No. 63/359,059 titled “Wearable Mechanical Robotic Device” and having a filing date of Jul. 7, 2022, all of which is incorporated by reference herein.

### FIELD OF THE INVENTION

The present specification relates to a wearable robotic device, more particularly a device that improves operability when squatting or doing any squat-like activities using a mechanical robotic device.

### BACKGROUND OF THE INVENTION

Current systems that exist in the art contain a wide variety of exoskeletons to assist individuals in a number of different industries. For example, in a factory where heavy lifting is constant the wear and tear on an individual's body through the day and years creates significant wear on the individual's body which can lead to back, hip and knee problems. In industrial or military settings, a worker is constantly lifting heavy loads which may injure that individual due to poor body posture and constant strain on the worker's joints. Manual tasks in the industrial, military, and industrial setting, often result in the workers to fatigue quickly. When performing different tasks, the worker may kneel or crouch to pick up something using their arms and legs which potentially creates a painful posture or if the posture is correct pain and fatigue from the constant lifting. This painful posture is caused by the sharp bending of the knee, hip and back when bending over to lift a heavy item off the ground. These issues are sometimes compounded by the heavy personal protection equipment (PPE) or other gear the workers must wear to complete their work.

Wearable robotics have been developed to aid these workers and to help alleviate some of the weight off the individual's joints and body allowing the user to work longer and more efficiently without the added stress on the worker's body. Current systems usually are big and bulky requiring multiple systems and extensive strapping attached to the worker's back and legs creating a counter pressure at the user's chest. These systems usually require multiple motors, gears, sensors, and a controller to determine when the worker is bending over to lift an item, sitting, or walking. These robotic systems can be worn on the worker's legs, torso, or arms. Load assistance structures and exoskeletons add external weight to the user even while supporting the weight of the carried load. The weight of the exoskeleton itself can cause issues with the worker and can encumber the worker because of its large size and weight. In addition, current solution requires the user to intervene by activating or deactivating the device manually and do not allow the user to disengage the device while in squatting or in the squatting motion. Other known solutions only assist with specific tasks while interfering with others.

Therefore, there is a need for a wearable robotic device that is light in weight and allows the user to move about unencumbered without the added weight of motors and gears which allows for squat recovery but recognizes when the worker is not completing a non-squat task.

### BRIEF SUMMARY OF THE INVENTION

The present invention provides amount other things a wearable mechanical robotic device providing assistance torque to a user about the hip joint, the device comprising a housing accommodating an actuator coupled to a pin lock such that the pin lock allows a cam to rotate when the pin lock is in an unlocked position and prevents the cam from rotating when the pin lock is in a locked position. A cam follower that coupled to a plunger and engaged by the cam, wherein the plunger compresses a spring against a base. An outer frame having at least one guide for the pin lock. The housing is coupled to at least one outer frame. The at least one outer frame has a first pin guide, a second pin guide, and a first bearing guide.

The pin lock can be a rolling pin lock and the device can further comprise at least one first bearing coupled to a first pin wherein the at least one first bearing can move within the first bearing guide. The wearable mechanical robotic device can further comprise a pin lift plow, wherein the pin lift plow comprises at least one first guide pin and at least one second guide pin and can be coupled to the actuator.

The cam can be coupled to a second bearing and to at least one third bearing through a second pin. The wearable mechanical robotic device can further comprise a slide shuttle wherein the slide shuttle couples to a thigh interface located on a user wherein the vertical placement height is adjusted along the top of the user's thigh. The cam follower comprises at least one fifth bearing and a third pin wherein the third pin can couple to the at least one fifth bearing, plunger and fourth bearing. The wearable mechanical robotic device can further comprise at least two spring supports removably coupled together by a base and a second fastener wherein each spring support has a support guide for the fifth bearing to traverse up and down in. The wearable mechanical robotic device can further comprise a motor coupled to the spring to selectively compress or release the spring. The motor selectively compresses or releases the spring by rotating a second nut by at least one gear, a belt and a threaded rod. The motor can passively alter the assistance torque.

A method of assisting a user's motion between a fully extended position to a bent position by providing torque to the user about the user's hip joint, the method comprising. Providing the wearable mechanical device according to wearable mechanical robotic device. Providing a microprocessor coupled to the pin lock and configured to selectively engage the pin lock to prevent compression or decompression of the spring. The method can further comprise providing at least one sensor to determine the center of gravity of the user and engaging or disengaging the pin lock based on the user's center of gravity. The sensor comprises at least one of an inertial detector and a position detector.

The method can further comprise providing at least one motor coupled to the spring and controlling the compression and/or extension the spring non-linearly. The method can further comprise holding the assistance torque constant over a range of motion of the user. The assistance torque can be held constant between a hip angle of between about 80 degrees and about 120 degrees. The assistance torque can be different when the hip angle of the user is increasing and decreasing. The motor can passively load a tension of the spring. The pin lock can be a rolling pin lock and the device can further comprise at least one first bearing coupled to a first pin wherein the at least one first bearing moves within the first bearing guide, the method can further comprise selectively engaging or disengaging the pin lock while the spring is at least partially compressed.

The user can select between having the spring always engaged with the cam, have the spring always disengaged from the cam, and having a microprocessor selectively engage and disengage the spring and the cam. The device further comprises a battery and a microprocessor to selectively engage the pin lock to prevent compression or decompression of the spring, the method further comprising selectively engaging the pin lock to prevent compression or decompression of the spring to extend the life of the battery. The spring can be engaged to the cam whenever the user's center of gravity is in front of the heel of the user. The joint is the hip, shoulder, elbow, knee, or ankle.

A wearable mechanical robotic device that can provide assistance torque to a user about a joint, the device comprising a first body interface couple to a cam body, the cam body having a first axis on a first side of the joint. A second body interface coupled to a spring body, the spring body having a base end, a cam interface end, and a second axis on a second side of the joint, wherein the second axis is orthogonal to or at an oblique angle to the first axis, and wherein the second body interface has a base end and a plunger end. A cam can have an axis of rotation coupled to the first body interface such that when the first axis is rotated by movement of the user about the joint the cam is rotated about the axis of rotation. A spring can be coupled to the spring body and sharing the second axis. A plunger can be coupled to the spring at the cam interface end such that rotation of the cam engages the plunger to compress the spring against the base. A motor can be coupled to the base or the cam to selectively actuate the base or the cam to compress the spring or to disengage the spring from the cam.

It is an objective of the invention to allow a user to comfortably complete a non-squat task without consciously deactivating the system.

It is an objective of the invention to encourage proper recovery posture by actuating only when good posture is confirmed.

It is an objective of the invention to be easily and quickly donned and doffed.

It is an objective of the invention to save power and energy by using spring force instead of motors to assist the joint and to give the user a robust and repeatable robotic device for the user's joints. Additionally, the user will have a more repeatable operation by using the user's center of gravity to selectively engage and disengage the device.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is a side view of exemplary embodiment of a wearable robotic device in accordance to one, or more embodiments;

FIG. 2 is a side view of another embodiment of a wearable robotic device in accordance to one, or more embodiments;

FIG. 3 is a side view of another embodiment of a wearable robotic device in accordance to one, or more embodiments;

FIG. 4 is a side view of another embodiment of a wearable robotic device in accordance to one, or more embodiments;

FIG. 5 is a side view of another embodiment of a wearable robotic device in accordance to one, or more embodiments;

FIG. 6 is a side view of another embodiment of a wearable robotic device in accordance to one, or more embodiments;

FIG. 7 a side view of another embodiment of a wearable robotic device in accordance to one, or more embodiments;

FIG. 8 a isometric view of the preferred embodiment of a wearable robotic device in accordance to one, or more embodiments;

FIG. 9 an isometric view of the preferred embodiment, the cover and frame being omitted, of a wearable robotic device in accordance to one, or more embodiments;

FIG. 10 a side view of preferred embodiment, the cover being omitted, of a wearable robotic device in accordance to one, or more embodiments;

FIG. 11 an isometric view of the preferred embodiment, the cover being omitted, of a wearable robotic device in accordance to one, or more embodiments;

FIG. 12 a side view of the preferred embodiment, the cover, spring support, and frame being omitted, of a wearable robotic device in accordance to one, or more embodiments;

FIG. 13 a side view of the preferred embodiment, with multiple components being omitted, of a wearable robotic device in accordance to one, or more embodiments;

FIG. 14 a side view of the preferred embodiment attached to a user of a wearable robotic device in accordance to one, or more embodiments;

FIG. 15 a side view of the preferred embodiment cam of a wearable robotic device in accordance to one, or more embodiments;

FIG. 16 a side view of another embodiment of a wearable robotic device in accordance to one, or more embodiments;

FIG. 17 a side view of another embodiment cam of a wearable robotic device in accordance to one, or more embodiments;

FIG. 18 a side view of another embodiment cam of a wearable robotic device in accordance to one, or more embodiments;

FIG. 19 a side view of another embodiment cam of a wearable robotic device in accordance to one, or more embodiments; and

FIG. 20 is a spring force and joint torque diagram of the wearable robotic device as the user's hip bends at an angle.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

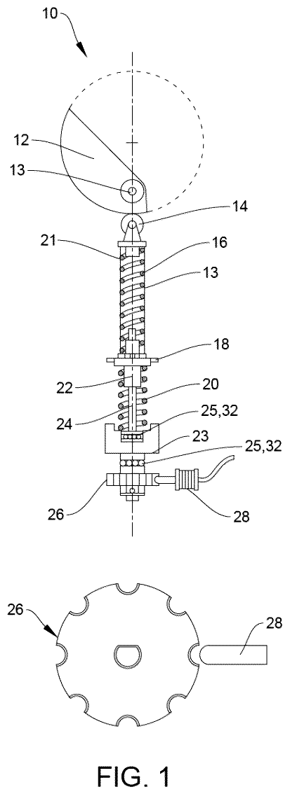

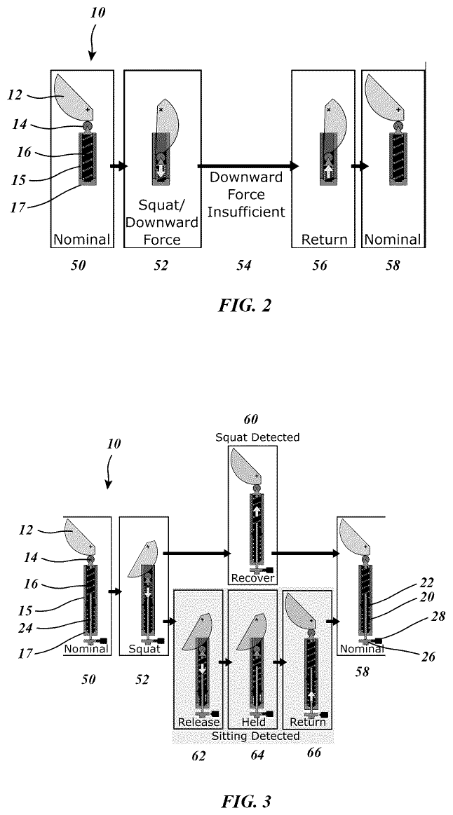

Referring initially to FIG. 1 a of a wearable mechanical robotic device is shown generally at 10. The wearable robotic device 10 can comprise a cam 12 wherein the cam can be attached to a cam pin 13 which can allow the cam to rotate freely. The cam 12 can be attached to the wearer's hip or in other embodiment shoulders, thighs or other parts of the wearer's body. The cam 12 can come into connect with a follower 14 wherein the follower can spin freely on a bearing of a pin (not shown) wherein the follower can stay in constant contact with the outer profile of the cam as shown in FIG. 2. The cam 12 can be any shape cam such as, for example, round, oval, elliptical or the like, but in the preferred embodiment the cam is an eccentric circle. The cam 12 can be fixed relative to a plate structure (not shown) secured to the wearer's hips. As the wearer bends, the cam 12 can rotate relative to the follower 14. The cam 12 can push on the follower 14 wherein the follower can move freely axially within a tube 15 wherein the follower can compress a lift/squat spring 16 that can be contained within the tube.

The follower 14 can move axially freely within the tube 15 wherein the follower can have an outer diameter that can be smaller than the inner diameter of the tube. The follower 14 can be affixed to the end of the lift/squat spring 16 by such as, for example, weld, glue, press fit, loose fit, or the like. In other embodiments the follower 14 and the tube 15 can be such as, for example, circular, square, rectangular, hexagonal or the like in shape. The tube 15 can have an upper end 21 and a lower end 23 wherein the upper end can have a slot (not shown) in it for the cam that is pushing against the follower 14 to freely pass through the tube. In certain embodiments the slot can be omitted.

In embodiments, a ball nut 22 can be connected to at least one anti-rotation pin 18 wherein the anti-rotation pins can be attached to the ball nut and/or an anti-rotation device, wherein the ball nut and the anti-rotation device can be inserted into the tube 15. The lift/squat spring 16 can push against the anti-rotation device and/or the ball screw 24 thus causing the spring to react and push against the follower 14. The ball screw 24 can be turned by the translating ball nut 22 and is itself translationally locked and rotationally free. The tube 15 can have at least one anti-rotation slot (not shown) for the anti-rotation pins 18 to slide into and react against keeping the ball nut 22 stationary. The anti-rotation slot (not shown) can be such as, for example, a thru slot, a partial through slot, or the like wherein the anti-rotation slot can be sized accordingly to allow for the anti-rotation pins 18 to freely move up and down in the tube while not allowing the ball nut to rotate within the tube 15. The ball nut 22 can have a ball screw 24 that can move rotationally through the ball nut wherein the ball screw can be attached to an upper thrust bearing 25 wherein the upper thrust bearing allows for the ball screw to be axially loaded from the lift/squat spring 16 and the return spring 20. The return spring 20 can have a weaker spring force then the lift/squat spring.

The lower end 23 of the tube 15 can have an end cap 17 attached to it wherein the end cap can be such as, for example, welded on, press fit on, screwed on, or the like to the tube. The upper thrust bearing 25 can be attached or captured between the end cap 17 and the return spring 20 wherein the thrust bearing can be sized accordingly to fit into the tube 15 and can allow the ball screw to rotate freely with a load pushed up against it axially. The ball screw 24 can be machined accordingly on its lower shaft to allow for the ball screw to fit into the bore of the upper thrust bearing 25 wherein the ball screw can be such as, for example, press fitted, welded, glued, set screwed, pinned, or the like into the upper thrust bearing 25. The ball screw 24 shaft can continue past the end cap 17 wherein the ball screw can fit into the bore of a lower thrust bearing 32 and a bore of a locking gear 26 wherein the ball screw can be such as, for example, press fitted, welded, glued, set screwed, pinned, or the like into the lower thrust bearing and the locking gear.

The end cap 17 can have a through hole wherein the ball screw 24 shaft can pass through the through hole and can be attached to a lower thrust bearing 32 and a locking gear 24 by such as, for example, press fit, weld, glue, set screw, pin, or the like. A solenoid 30 can be place so that it can actuate into the path of the locking gear 34 teeth. The solenoid 30 can be such as, for example, a linear solenoid, rotary solenoid, laminated solenoid, frame solenoid or the like. The solenoid can be attached to a frame which is attached to the wearer's thigh or hip (not shown). Referring to FIG. 2, shows another embodiment of a wearable robotic device 10.

At 50 a cam 12 can be push against the follower 14 at the nominal position before squatting or putting a downward force on the wearable robotic device 10. The lift/squat spring 16 is contained by the tube 15. At step 52 the user squats creating a downward force on the lift/squat spring 16 thus compressing the lift/squat spring 16 and storing the input force. At step 56, the user can stand from the squatting position and the lift/squat spring 16 acts through the follower 14 on the cam 12, pushing against and adding torque to the user's hips, assisting in standing returning the cam to its nominal position at step 58. As the user sites, the lift/squat spring 16 acts through the follower 14 on the cam 12, which can add torque to the hips. As the user stands from the seated position, the lift/squat spring 16 acts through the follower 14 on the cam 12 which adds torque to the hips, assisting in standing. This embodiment is simple and requires no power to be operated by the user. The lift/squat spring 16 can be customizable and can provide minimal resistance when the user is walking and can provide a way for the user to lean against the lift/squat spring without committing to a squat.

Referring to FIG. 3, another embodiment of a wearable robotic device 10. In this embodiment, at step 60 and 62 the user is in nominal position and then begins to squat. As the user's squats the cam 12 pushes against the follower 14 resulting in the follower pushing down on the lift/squat spring 16. The lift/squat spring 16 holds a force on the ball nut 22 wherein the ball nut is stationary until the solenoid 28 releases the locking pin 30 from the locking gear 34. At step 62, as the locking pin releases the locking gear the lift/squat spring 16 pushes the ball nut 22 down resulting in the ball screw rotating the locking gear and compressing the return spring. At step 64, the solenoid can hold the ball screw 24 in place until the user wants to stand from the squatting position, wherein the solenoid remains extended and the lift/squat spring acts through the follower on the cam 12 adding torque to the user's hips assisting in standing. The solenoid 28 remains in the extended position and the cam 12 presses into the follower 14 and compressing the lift/squat spring 16. The lift/squat spring 16 can press onto the ball nut 22 resulting in the ball screw 24 to rotate which turns the locking gear 34. The ball screw 24 can be held in place as the lift/squat spring 16 is compressed by the solenoid reacting on the locking gear 34.

The wearable robotic device 10 can determine if the user is in the seated position wherein the if the user is determined to be in the seated position, the solenoid 28 retracts and the lift/squat spring 16 acts on the return spring 20 which results in the releasing of the stored energy and allows the user to sit comfortably, as step 64 and 66. While the user is seated, the solenoid is held to stop the return spring 20 from acting on the user. When the user stands from the seated position, the energy has already been released and the user will return to the standing position largely unassisted. The solenoid 28 will retract and the return spring 20 will return the follower 24 against the cam 12 to prepare for the next activity by the user at step 60. At step 58, the user completes the normal walking and running activities wherein the interaction of the cam 12 and the lift/squat spring 16 and the return spring 20 allows for minimally restrained motion during the motions. The lift/squat spring 16 is not significantly charged and therefore not restraining motion, until the user is out of the band of the normal human gait cycle.

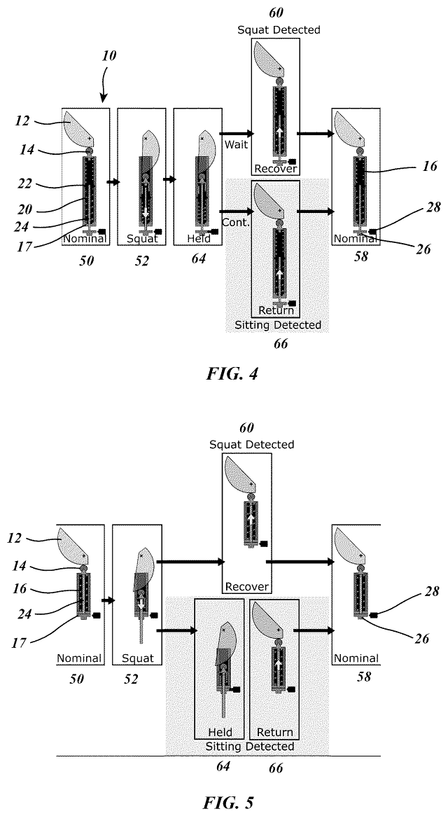

Referring to FIG. 4, another embodiment of a wearable robotic device 10 wherein as the user squats, the solenoid 28 remains in the retracted position and the cam 12 presses into the follower 14 and thus in the return spring 20. The return spring 20 can presses into the ball nut 22 wherein the ball nut is translated downward, compressing the lift/squat spring 16 and rotating the locking gear 34. As the user stands the solenoid 28 remains retracted and the lift/squat spring 16 and return spring 20 can act through the follower 14 on the cam 12 which can add torque to the hips, assisting in standing. The return spring 20 ensures the follower 14 is in place for the next squat.

As the user is determined to be in the seated position, the solenoid 28 extends. The lift/squat spring 16 remains charged but locked by the solenoid locking pin 30 which can allow the user to comfortably sit with only the return spring 20 pressing on the follower 14 and cam 12. As the user stands, the solenoid 28 retracts and the lift/squat spring 16 acts through the follower 14 on the cam 12 which adds torque to the hips, assisting in standing. The user then can then resume with normal walking and running activities.

Referring to FIG. 5, another embodiment of a wearable robotic device 10 wherein as the user squats, the solenoid 28 remains in the retracted position, at step 50. As the user squats the cam 12 pushes the follower 14 and it slides down the tube 15 compressing the lift/squat spring 16 and rotating the locking gear 26 through the ball nut 22 and ball screw 24, at step 52. As the user stands, the solenoid 28 remains retracted and the lift/squat spring 16 acts through the follower 14 on the cam 12 which can add torque to the hips, assisting in standing at step 66. As the user is determined to be in the seated position, the solenoid 28 can extends locking the locking gear 34 in place. The lift/squat spring 16 remains charged but locked due to the locking gear 26 being locked by the solenoid 28 which can allow the user to comfortably sit with no action force on the cam 12 at step 64. As the user stands, the solenoid 28 can be retracted releasing the locking gear 26 and the lift/squat spring 16 acts through the follower 14 on the cam 12 at step 66 which can add torque to the hips, assisting in standing and the wearable robotic device is returned to its nominal position, at step 58.

Referring to FIG. 6, yet another embodiment of a wearable robotic device 10 wherein as the user squats, the solenoid 28 remains in the extended position and the cam 12 presses into the follower 14 compressing the lift/squat spring 16 at step 50 and step 52. The follower 14 can be connected to a rack gear 38 wherein the as the user squats the follower is compressed into the tube 15 wherein each gear on the rack gear passes by the solenoid 28 resulting in the follower 14, rack gear and cam 12 being locked in place at step 52. At step 64, the return motion provided by the compressed lift/squat spring 16 is held in place by the solenoid 28. As the user stands, the solenoid 28 retracts and the lift/squat spring 16 acts through the plunger 174 on the cam 12, at step 66 which can add torque to the hips, assisting in standing. As the user is determined to be in the seated position, the solenoid 28 remains extended and the lift/squat spring 16 charged but locked, which can allow the user to comfortably sit with no action force on the cam 12, at step 60. As the user stands, the solenoid 28 retracts and the lift/squat spring 16 acts through the plunger 174 on the cam 12, at step 66, which can add torque to the hips, assisting in standing. The designed interaction of the cam 12 and lift/squat spring 16 can allow for minimally restrained motion during walking and running activities. The lift/squat spring 16 is not significantly charged and therefore not restraining motion, until the user is out of the band of the normal human gait cycle.

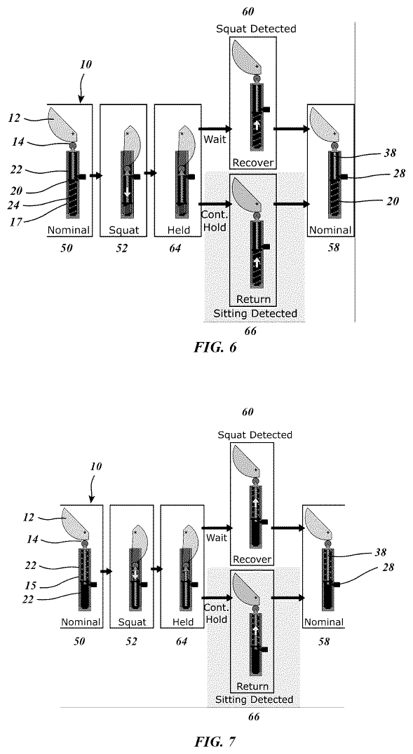

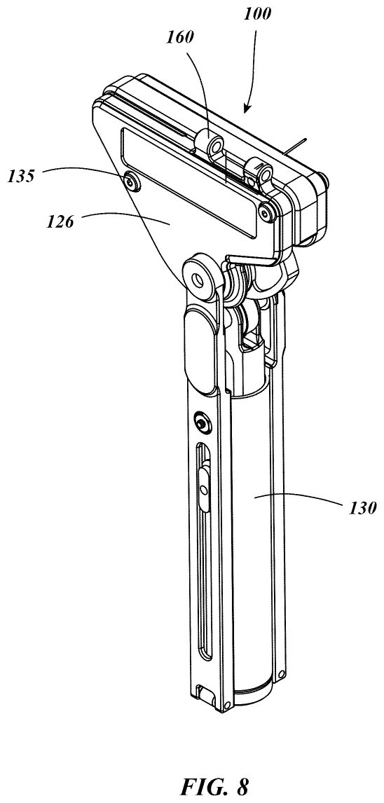

Referring to FIG. 7, and yet another embodiment of a wearable robotic device 10 wherein as the user squats, the solenoid 28 remains in the extended position and the cam presses into the follower 14 and rack gear 38 and thus into the lift/squat spring 16. Return motion provided by the compressed lift/squat spring 16 is held in place by the solenoid 28. As the user stands, the solenoid 28 retracts and the lift/squat spring 16 acts through the follower on the cam 12 which can add torque to the user's hips, assisting in standing. In all conditions, at the base of the squat, the system maintains the charged lift/squat spring 16 until the next action is determined. As the user is determined to be in the seated position, the solenoid 28 remains extended, and the lift/squat spring 16 charged but locked which can allow the user to comfortably sit with no action force on the cam 12. As the user stands, the solenoid 28 retracts and the lift/squat spring 16 acts through the follower 14 on the cam 12 which can add torque to the hips, assisting in standing. User completes normal walking/running activities the designed interaction of the cam 12 and lift/squat spring 16 can allow for minimally restrained motion during walking and running activities. The lift/squat spring 16 is not significantly charged and therefore not restraining motion, until the user is out of the band of the normal human gait cycle.

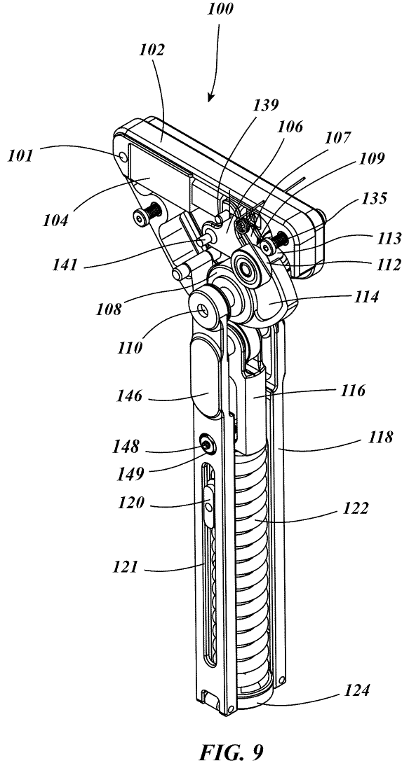

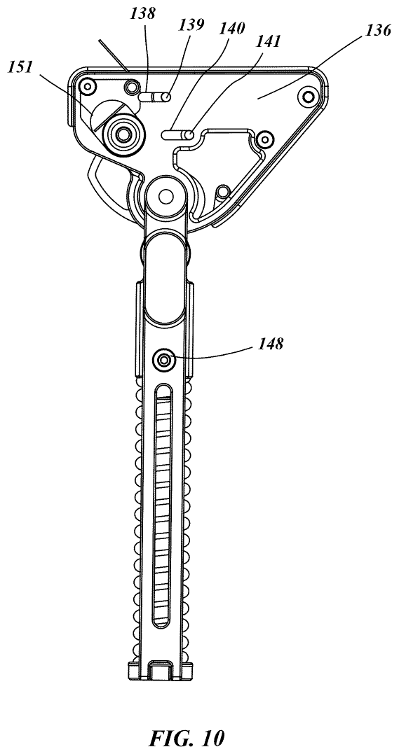

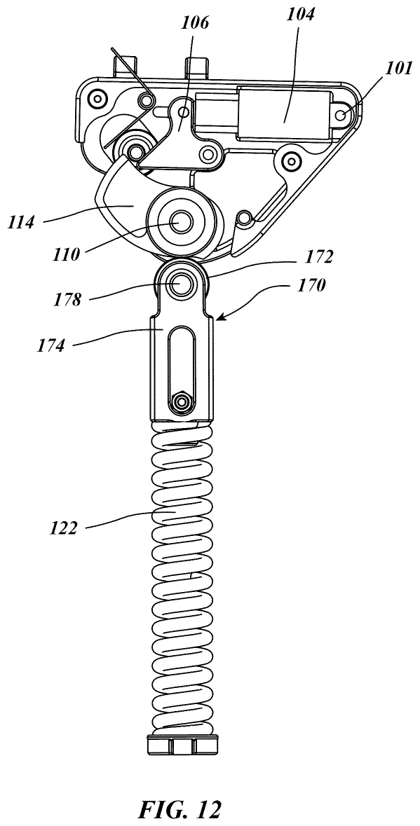

Referring to FIGS. 9-11, shows a preferred embodiment of a wearable mechanical robotic device 100 for providing assistance torque to a user about a joint. The wearable mechanical robotic device 100 can comprise a housing 102 that accommodate an actuator 104 coupled to a pin lock 109 such that the pin lock allows a cam 114 to rotate when the pin lock is in an unlocked position and prevents the cam from rotating when the pin lock is in a locked position. The housing 102 can have a first attachment point 101 wherein the actuator 104 can be coupled to the housing by the first attachment point and coupled to a pin lift plow 106. The actuator 104 can be attached to the housing 102 by such as, for example, fasteners, pinned, captured or the like. The actuator 104 can be such as, for example, linear actuator, rotary actuator, pneumatic actuator, mechanical actuator or the like. The pin lift plow 106 can be comprise at least one first guide pin 139 and at least one second guide pin 141 wherein the first guide pin and the second guide pin can protrude from one side or both sides of the pin lift plow. The pin lift plow 106 can have a channel 107 separate its sides wherein the pin lift plow can be any suitable shape, but the preferred shape of the pin lift plow is shown in FIG. 12.

In embodiments the wearable mechanical robotic device 100 can further comprise a pin lock 109 wherein the pin lock can comprise at least one first bearing 112 coupled to a first pin 113 wherein the at least one first bearing moves within the bearing guide. The pin lock 109 can be a such as, for example, a rolling pin lock, stationary pin lock, actuated lock, or the like. The pin lift plow 106 can push against the pin lock 109 on its first pin 113 wherein the pin lift plow can be coupled to the actuator. In the preferred embodiment the pin lock 109 can comprise two first bearings 112 and a first pin 113 that connects the two first bearings together.

The wearable mechanical robotic device 100 can further comprise at least one outer frame 136 having at least on guide for the pin lock 138, 140 that is coupled to the housing 102. In the preferred embodiment the outer frame 136 can be on both sides of the housing 102 and can be connected to the housing by at least one fastener 135 wherein a fastener can be such as, for example, bolt, screw, rivet, weld, adhesive, or the like. In the preferred embodiment, the outer frame 136 can have a first pin guide 138, a second pin guide 140, a first bearing guide 151. The outer frame 136 can have at least one cover 126 attached to the outer frame by at least one fastener 135 wherein the cover can be on both side of the outer frame and the outer frame can have at least one hip connection point 128.

The first bearing guide 151 can contain and guide the at least one first bearing 112 in an angular motion wherein the first bearing guide can be vertical, or horizontal or any angle between horizontal and vertical such as, for example, at least 0 to 90 degrees. The first pin guide 138 can guide and capture the first guide pin 139 and the second pin guide 140 can guide and capture the second guide pin 141 wherein the first pin guide and the second pin guide can guide the first guide pin and the second guide pin on a path as the pin lift plow moves back and forth as the actuator 104 pushes the cam forward and backwards wherein the first pin guide and the second pin guide can limit the pin lift plow's motion back and forth.

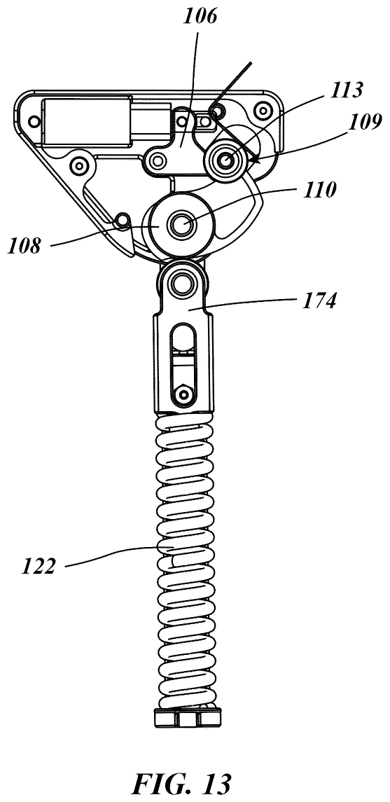

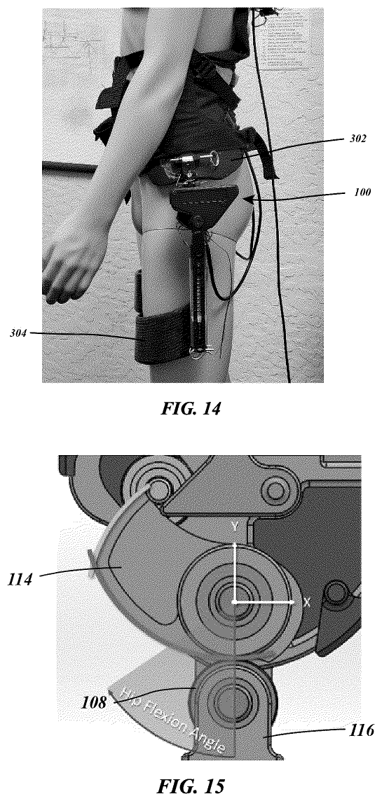

In embodiments the wearable mechanical robotic device 100 can further comprise a cam 114 wherein the cam 114 can be any suitable shape, but in the preferred embodiment has the shape as shown in FIG. 12. The cam 114 can be coupled to a second bearing 108 and a second pin 110 and to at least one third bearing through a second pin 110. The cam 114 is rotatable around the second pin and second bearing 108 as shown in FIG. 13. The second pin 110 can extend past the second bearing 108 and can support at least one third bearing 150. The second pin 110 can go through the outer frame's 136 second through hole wherein the at least one third bearing 150 can be such as, for example, press fit, loose fit, interreference fit or the like onto the second pin and over the outside of the outer frame. The outer frame 136 can further comprise a first body interface connection 160 wherein the link attachment can attach to a first body interface 302 such as a belt that is on the user as shown in FIG. 14. The first bearing 112 can move freely within the first bearing guide 151 wherein the fit can be a loose fit enough for the bearing to not rattle within the first bearing guide.

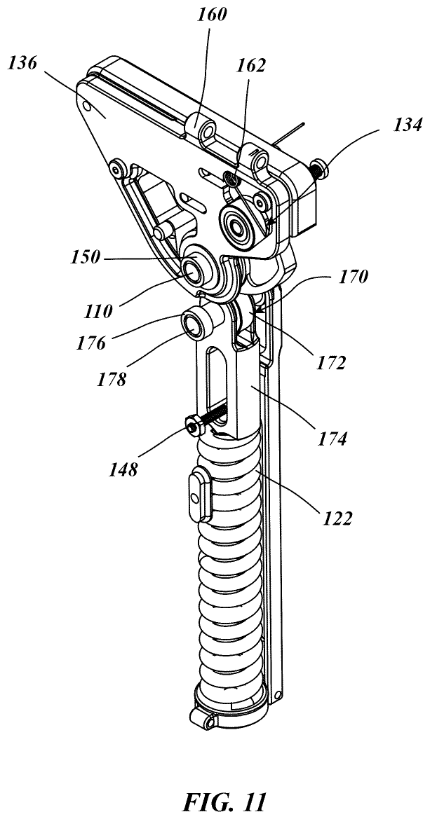

The wearable mechanical robotic device 100 can further comprise a cam follower 170. The cam follower 170 can be coupled to plunger 174 and can be engaged by the cam 114 wherein the plunger can compress the spring 122 against the base. The cam follower 170 comprises a fourth bearing 172, a third pin 178, at least one a fifth bearing 176 and a plunger 174 wherein the third pin can be coupled to the at least one fifth bearing, plunger and fourth bearing. The plunger 174 can have an upper portion and bottom portion wherein the upper portion can have the fourth bearing 176 attached to it through the third pin 178 and the bottom portion can have a spring 122 attached to it. The fourth bearing 172 can rotate freely around the third pin 178 and within the upper portion of the plunger 174. The plunger 174 can be any suitable shape, but the preferred shape is shown in FIG. 11.

The fourth bearing 172 can follow the cam 114 outside profile as the cam rotates wherein as the cam rotates the plunger 174 moves up and down and as the plunger moves up and down the spring can be compressed or released. The fifth bearing 176 can rotate within a support guide 146 within at least two spring support 118 wherein in the preferred embodiment there can be a spring support on each side of the wearable mechanical robotic device 100. The spring support 118 can extend from the third bearing 150 to the bottom of the spring 122 wherein the two spring supports can be connected by a base 124 wherein the base can support the spring 122. The base 124 can be removable allowing the user to easily replace the spring 122 with a heavier or lighter spring. The spring 122 can be surrounded by a spring tube 130 wherein the spring tube can be placed in-between the spring support 118 and the spring 122 and having an opening on the top and bottom allowing the spring and the plunger 174 to easily slide within the tube. The spring tube 130 can be partially open on one end, both ends, or it can be fully enclosed or fully open on one end or both ends. The spring tube 130 can dampen the spring 122 as it returns to its normal state which can limit the energetic release when the cam 114 is unlocked. The spring 122 can be such as, for example a pneumatic spring, coil spring, compression spring, constant force spring or the like.

The cam follower 172 can compress the spring 122 against the base 124 as the cam 114 rotates. The at least two spring support 118 can have a through hole that can support a second fastener 148 and first nut 149 that can keep the spring 122 from releasing past the bolt wherein the second fastener can come into contact with the plunger 174, and it can retain the spring support 118 keeping the spring support from separating on their respective ends. The second fastener 148 can couple the at least one spring supports 118 together. A slide shuttle 120 can be the point of attachment for a second body interface 304 located on a user, as shown in FIG. 14, located on the user wherein the adjust the vertical placement height along the top of the thigh. The slide shuttle 120 can be use the spring support 118 to carry the torque generated between the actuator and thigh and the slide will be friction locked (tightening the screw) to hold its vertical positioning. The slide shuttle 120 can slide within a slide shuttle guide 121 on the spring support 118 wherein the slide shuttle guide keep the slide shuttle from moving past a distance on the spring support. Each spring support 118 can have a support guide 146 for the fifth bearing 176 to traverse up and down in.

In embodiments, the first bearing 112, second bearing 108, third bearing 150, fourth bearing 172 and the fifth bearing 176 can be such as, for example, a thrust bearing, ball bearing, roller bearing, fluid bearing, magnetic bearing, or the like. The wearable robotic device 100 can further comprise at least one second bearing 108 wherein the at least one second bearing can be attached to a second pin 110. The first bearing 112 can have a second spring 162 that can push down on it so the second spring can stay seated within the first bearing guide 151.

In embodiments, the method of operating the wearable mechanical robotic device 100 comprises a cam 114, a cam follower 170, a spring 122, a pin lock 109, and a actuator 104. The hip joint flexion resistance is accomplished through use of the cam 114 and the cam follower 170. As the user hip flexion motion is achieved the cam follower 170 is used to ride along the surface of the cam 114 and as a result is driven downward and away from the user's pivoting joint, thus creating deflection in the spring 122. The motion and interaction create a reaction force in both the vertical (spring deflection direction) and horizontal direction. The result is a torque resistance to the flexion of the actuator hip joint.

The engagement and disengagement of the spring force is accomplished (in this embodiment) by the release of the cam 114. The pin lock 109, when in the down position creates a direct interference to the backward rotation of the cam 114, thus coupling the cam to the rotation orientation of the main actuator body. When the actuator 104 is extended, the pin lock 109 is pushed upward and rolls out from under the reaction loads of the cam 114. This allows the release of the cam 114 and its decoupling from the main actuator body. This backward motion of the cam 114 is the result of the stored energy of the spring 122 pushing the cam follower 170 into the lower cam surface. The base 124 can be used to quickly swap out springs to support different load resistance ranges and can be permanently attached or removably attached to the spring supports. The actuator 104 can be used to push and translate the pin lift plow 106 forward. The sloped surface of the pin lift plow 106 is used to lift the pin lock 109 out from behind the rear cam 114 surface, thus decoupling the cam motion from the main actuator body. Utilizing a rolling friction concept, the actuator 104 and pin lift plow 106 can provide a minimal force to lift the pin lock 109, even when the pin is under its maximum reaction loads from the cam 114.

The preferred profile of the cam 114 is shown in FIG. 15. The cam 114 profile shown operates in two basic modes. The primary torque resistance mode represented by the longer curve and the peak hold resistance mode, represented by the shorter curve on the cam 114. Having a eccentric circle model, provides a non-linear torque resistance to the hip flexion but other models can be used. The resistance is very low for the first 40 degrees of flexion and then becomes increasingly higher (almost linear) as the angle of flexion becomes deeper. The shorter cam 114 curve can be a nearly constant radius region which can provide a constant torque resistance for the final range of hip flexion. The constant radius is relative to the hip joint, point of rotation within the mechanism creating a nearly constant that is come minor amount of slope needed to prevent the mechanism from sticking. The minor slope can ensure that the mechanism can passively unload as the hip flexion angle returns to neutral standing angles.

The specific cam 114 profile used is not fixed and could potentially be shaped in any number of ways to accomplish different desired flexion/torque resistance responses such as, for example the cam can have one continuous slope instead of two slopes as shown in FIG. 15. If a continuously increasing torque response is required, the cam 114 could be designed to eliminate the constant torque region and the cam profile can be continued throughout the full range of motion. If instead of a non-linear torque response, another cam 114 profile could be generated to create a linear response through the range of motion. In the field of mechanical engineering, the cam 114 design process and limitations are very well described, and cam profiles can be generated to create any number of torque responses. The key is that the spring 122 energy be decoupled from the actuator 104 and thus the wearers hip joint. Possible methods include rotation away from load by the cam 114 (current embodiment), the base of the spring could be released in order to dissipate spring energy. The cam follower 170 could be allowed to rotate (horizontal motion) to separate from the cam surface. Conversely the cam 114 could shift horizontally, to separate from the cam follower 170.

In embodiments the wearable mechanical robotic device 100 can be quasi-active wherein it can comprise sensors that transmit data to an electrical component that has a microcontroller (“MCU”) that can control the actuator 104 and when it is actuated or released when the user is in certain positions while squatting, sitting, walking, or other activities while wearing the wearable mechanical robotic device 100.

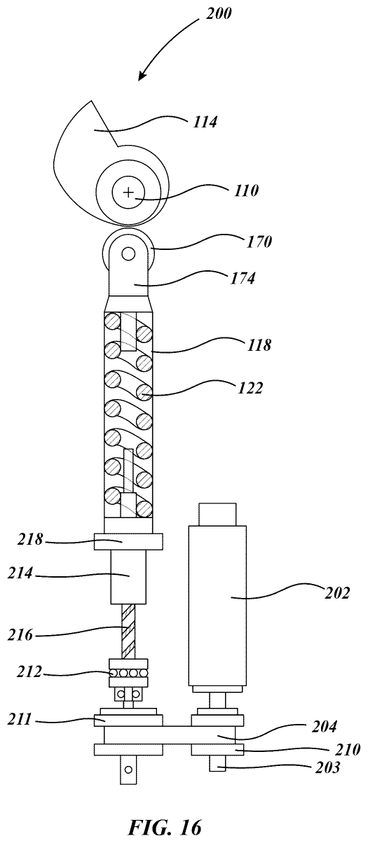

Referring to FIG. 16 another embodiment of a mechanical robotic device is shown at 200. The mechanical robotic device 200 can comprise a cam 114 having the same or similar shape as mentioned above. The cam 114 can be rotationally coupled to the second pin 110 wherein the second pin can keep the cam on a circular path as the cam follower 170 pushes against the cam. The cam follower 170 can be coupled to the plunger 174 wherein the plunger can react against the spring 122 as a second nut 214 pushes against spring support 218 as the nut moves up and down on a threaded rod 216. The second nut 214 can be such as, for example, ACME nut, ball bearing nut, flange nut, round nut, or the like. The threaded rod 216 can be coupled to a bearing 212 wherein the bearing can be coupled to a first gear 211.

The first gear 211 can be coupled to a second gear 210 by a belt 204 wherein the second gear is coupled to a motor 202 by a motor shaft 203. The motor 202 can rotate the second gear 210 which can rotate the first gear 211 by a belt 204. The motor 202 can be coupled to the spring 122 to selectively compress or release the spring. The motor 202 can selectively compresses or releases the spring 122 by rotating a second nut 214 by at least one gear 211, a belt 204 and a threaded rod 216 or the cam 114. The motor 202 can passively alters the assistance torque.

The first gear 211 can rotate the threaded rod 216 which can move the nut 214 up and down on the threaded rod which can compress the spring and keep resistance on the cam 114 or release tension on the cam. The cam follower 170 can be such as, for example a ball bearing, a fluid bearing, spherical bearing, or the like. The cam follower 170 can rotate freely on the cam 114. The motor 202 can be such as, for example an AC motor, brushless motor, DC motor, or the like.

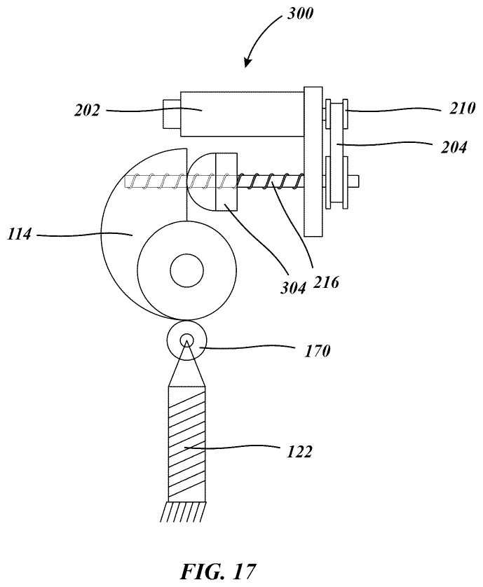

FIG. 17, shows another embodiment of mechanical robotic device 300 wherein the mechanical robotic device can have all the same, similar or omitted components as the mechanical robotic device 10. The mechanical robotic device 300 can be horizontal instead of vertical and can have a push block 304 that moves on the threaded rod 216 pushing on the cam 114 which can react against the cam follower 170 and the spring 122.

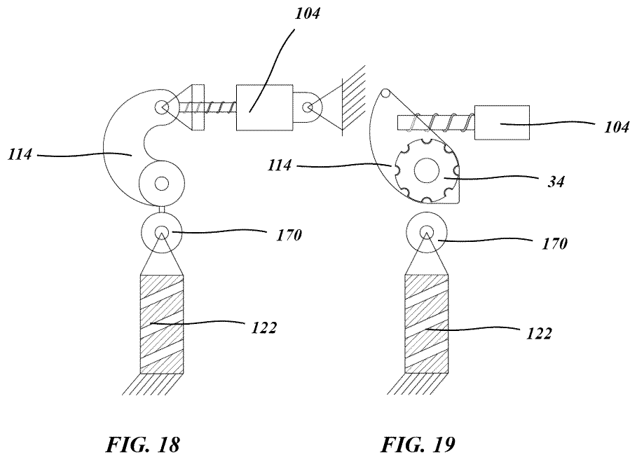

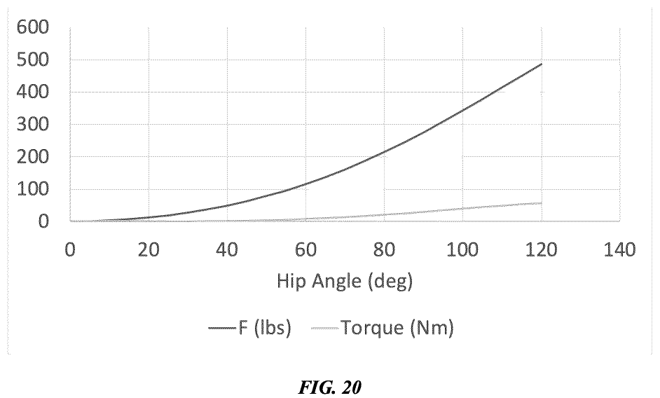

FIG. 18 and FIG. 19 shows two more embodiments where the cam 114 can be a different shapes and sizes and can be attached to a locking gear 34 as shown in FIG. 19. The actuator 104, as shown in FIG. 18, can push against the cam 114 reacting against the cam follower 170 and the spring 122. The motor 104 can couple or uncouple the cam 114 allowing the system to locked or unlocked which can replace the rolling pin lock 109 in FIG. 9. The spring 122 can be compressed or released through the motor 202 adjusting or altering the passive torque response on the cam 114. By adjusting either the base spring 122 preload and/or by advancing or retracting the rotation of the cam 114, in response to the user's movements, variations in the torque response is achieved. For example, instead of a simple “hill” shaped torque response to squatting and standing, the “hill” plateau can be extended to provide the maximum level of torque for a greater return to standing maneuver.

In embodiments the mechanical robotic device can provide a method of assisting a user's motion between a fully extended position to a bent position by providing torque to the user about the user's hip joint, the method comprising providing the wearable mechanical device according to mechanical robotic device as described above. Providing a microprocessor coupled to the pin lock and configured to selectively engage the pin lock 109 to prevent compression or decompression of the spring 122. Providing at least one sensor to determine the center of gravity of the user and engaging or disengaging the pin lock 109 based on the user's center of gravity wherein the sensors comprise at least one of an inertial detector and a position detectors. The method can further comprise providing at least one motor 202 coupled to the spring 122 and controlling the compression and/or extension the spring non-linearly. The method can further comprise holding the assistance torque constant over a range of motion of the user. The method can provide an assistance torque is held constant between a hip angle of between about 0 degrees and about 120 degrees. The method wherein the assistance torque is different when the hip angle of the user is increasing and decreasing.

The method wherein the motor 202 passively loads a tension of the spring 122 wherein the motor can move the second nut through the threaded rod 216 and gears 210 and 211 compressing the spring or releasing the spring creating a passive load as the spring compression is set. The user can set whether the spring is passively loading the spring or actively loading the spring while in use. The mechanical robotic device 200 can have a self-unlock mechanism at any position or at any load wherein the spring can always be engaged or disengage based on the center of gravity of the user. For example, if the center of gravity of the user is over the user's toes then the spring is engaged or if the center of gravity of the user is over or behind the user's heel then the spring is disengaged releasing the load of the mechanism.

The pin lock 109 can be a rolling pin lock and the device can further comprise at least one first bearing 112 coupled to a first pin 113 wherein the at least one first bearing moves within the first bearing guide 151 wherein the method can further compre selectively engaging or disengaging the pin lock while the spring is at least partially compressed. The user can select to have the spring always engaged, never engage, or engaged at certain flexion within the user's joint. The microprocessor can decide when to engage or disengage based on the center of gravity of the user as described above. The user can select between having the spring 122 always engaged with the cam 114, have the spring always disengaged from the cam, and having a microprocessor selectively engage and disengage the spring and the cam.

The method of the device can further comprise a battery and a microprocessor to selectively engage the pin lock 109 to prevent compression or decompression of the spring 122, the method can further comprise selectively engaging the pin lock to prevent compression or decompression of the spring to extend the life of the battery wherein the battery can store electrical energy for the system and can be substituted by similar behaving elements such as super capacitors. The wearable mechanical robotic device can provide the user with a battery savings over other devices because it is not using the heavily power consuming motors and gears other devices use. The spring 122 can be engaged to the cam whenever the user's center of gravity is in front of the heel of the user or other joint wherein the joint can be the hip, shoulder, elbow, knee, or ankle.

A wearable mechanical robotic device 100 can provide assistance torque to a user about a joint, the device can comprise a first body interface connection 160 couple to a cam body, the cam body having a first axis on a first side of the joint. A second body interface 304 coupled to a spring body, the spring body having a base end, a cam interface end, and a second axis on a second side of the joint, wherein the second axis is orthogonal to or at an oblique angle to the first axis, and wherein the second body interface has a base end and a plunger end.

A cam 114 can have an axis of rotation coupled to the first body interface 302 such that when the first axis is rotated by movement of the user about the joint the cam is rotated about the axis of rotation. A spring 122 can couple to the spring body and sharing the second axis. A plunger 174 coupled to the spring 122 at the cam interface end such that rotation of the cam 114 engages the plunger to compress the spring against the base 124. A motor 202 coupled to the base or the cam to selectively actuate the base or the cam to compress the spring or to disengage the spring from the cam.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

What is claimed is:

1. A wearable mechanical robotic device providing assistance torque to a user about a joint, the device comprising:
a housing accommodating an actuator coupled to a pin lock such that the pin lock allows a cam to rotate when the pin lock is in an unlocked position and prevents the cam from rotating when the pin lock is in a locked position;
a cam follower that coupled to a plunger and engaged by the cam, wherein the plunger compresses a spring against a base; and
a outer frame having at least one guide for the pin lock.

2. The wearable mechanical robotic device according to claim 1 wherein the spring is a pneumatic spring or a coil spring or other such elastic behaving element.

3. The wearable mechanical robotic device according to claim 1, wherein the housing is coupled to at least one outer frame.

4. The wearable mechanical robotic device according to claim 2, wherein the at least one outer frame has a first pin guide, a second pin guide, and a first bearing guide.

5. The wearable mechanical robotic device according to claim 3, wherein the pin lock is a rolling pin lock and the device further comprises at least one first bearing coupled to a first pin wherein the at least one first bearing moves within the first bearing guide.

6. The wearable mechanical robotic device according to claim 3, further comprising a pin lift plow, wherein the pin lift plow comprises at least one first guide pin and at least one second guide pin and is coupled to the actuator.

7. The wearable mechanical robotic device according to claim 1, wherein the cam is coupled to a second bearing and to at least one third bearing through a second pin.

8. The wearable mechanical robotic device according to claim 1, further comprising a slide shuttle wherein the slide shuttle couples to a thigh interface located on a user wherein the vertical placement height is adjusted along the top of the user's limb.

9. The wearable mechanical robotic device according to claim 1, wherein the cam follower comprises at least one fifth bearing and a third pin wherein the third pin can couple to the at least one fifth bearing, plunger and fourth bearing.

10. The wearable mechanical robotic device according to claim 8, further comprising at least two spring supports removably coupled together by a base and a second fastener wherein each spring support has a support guide for the fifth bearing to traverse up and down in.

11. The wearable mechanical robotic device according to claim 1, further comprising a motor coupled to the spring to selectively compress or release the spring.

12. The wearable mechanical robotic device according to claim 10, wherein the motor selectively compresses or releases the spring by rotating a second nut by at least one gear, a belt and a threaded rod or the cam.

13. The wearable mechanical robotic device according to claim 11, wherein the motor passively alters the assistance torque.

14. A method of assisting a user's motion between a fully extended position to a bent position by providing torque to the user about the user's joint, the method comprising:
providing the wearable mechanical device according to claim 1;
providing a microprocessor coupled to the pin lock and configured to selectively engage the pin lock to prevent compression or decompression of the spring.

15. The method of claim 14, further comprising providing at least one sensor to determine the center of gravity of the user and engaging or disengaging the pin lock based on the user's center of gravity.

16. The method of claim 15, wherein the sensor comprises at least one of an inertial detector and a position detector.

17. The method of claim 14, further comprising providing at least one motor coupled to the spring and controlling the compression and/or extension the spring non-linearly.

18. The method of claim 14, further comprising holding the assistance torque constant over a range of motion of the user.

19. The method of claim 18, wherein the assistance torque is held constant between a hip angle of between about 0 degrees and about 120 degrees.

20. The method of claim 18 wherein the assistance torque is different when the hip angle of the user is increasing and decreasing.

21. The method of claim 17 wherein the motor passively loads a tension of the spring.

22. The method of claim 14, wherein the pin lock is a rolling pin lock and the device further comprises at least one first bearing coupled to a first pin wherein the at least one first bearing moves within the first bearing guide, the method further comprising selectively engaging or disengaging the pin lock while the spring is at least partially compressed.

23. The method of claim 14, wherein the user selects between having the spring always engaged with the cam, have the spring always disengaged from the cam, and having a microprocessor selectively engage and disengage the spring and the cam.

24. The method of claim 14, wherein the device further comprises a battery and a microprocessor to selectively engage the pin lock to prevent compression or decompression of the spring, the method further comprising selectively engaging the pin lock to prevent compression or decompression of the spring to extend the life of the battery.

25. The method of claim 15, wherein the spring is engaged to the cam whenever the user's center of gravity is in front of the heel of the user.

26. The wearable mechanical robotic device according to claim 1 wherein the joint is the hip, shoulder, elbow, knee, or ankle.

27. A wearable mechanical robotic device providing assistance torque to a user about a joint, the device comprising:
a first body interface couple to a cam body, the cam body having a first axis on a first side of the joint;
a second body interface coupled to a spring body, the spring body having a base end, a cam interface end, and a second axis on a second side of the joint, wherein the second axis is orthogonal to or at an oblique angle to the first axis, and wherein the second body interface has a base end and a plunger end;
a cam having an axis of rotation coupled to the first body interface such that when the first axis is rotated by movement of the user about the joint the cam is rotated about the axis of rotation;
a spring couple to the spring body and sharing the second axis;
a plunger coupled to the spring at the cam interface end such that rotation of the cam engages the plunger to compress the spring against the base;
a motor coupled to the base or the cam to selectively actuate the base or the cam to compress the spring or to disengage the spring from the cam.
